(19) United States
(12) Patent Application Publication
(10) Pub. No.: US 2005/0165620 A1
(43) Pub. Date: Jul. 28, 2005

(54) Fundraising system, program product, and associated methods

(75) Inventors: Leonard G. Sturm, Pearland, TX (US); Johanna M. Lockhart, Houston, TX (US)

Correspondence Address: BRACEWELL & PATTERSON, LLP;IP DOCKETING, P.O. BOX 61389, HOUSTON, TX, 77208-1389, US

(73) Assignee: Houston Independent School District

(21) Appl. No.: 11/029,751

(22) Filed: Jan. 5, 2005

Related U.S. Application Data
(60) Provisional application No. 60/535,254, filed on Jan. 9, 2004.

(51) Int. Cl. G06F 17/60

(52) U.S. Cl. 705/1

(57) ABSTRACT

A method, system, and software for charitable contributions to a plurality of participant educational schools. The method includes enrolling a plurality of schools and vendors as participants in a charitable program, providing each of the participant plurality of primary and secondary schools a designator to identify each particular primary and secondary school participating in the charitable program, attaching at least one designator to transactions by each of the plurality of participant vendors, providing a sales incentive for each of the transactions having at least one designator attached thereto, and reporting the sales incentives provided and transactions with at least one participant school attached thereto reported by the vendor to an administrative server.

### RELATED APPLICATIONS

This nonprovisional patent application claims the benefit of co-pending, provisional patent application U.S. Ser. No. 60/535,254, filed on Jan. 9, 2004, which is hereby incorporated by reference in its entirety.

### BACKGROUND OF THE INVENTION

1. Field of the Invention

The invention relates generally to fundraising and, more particularly, systems program products, and methods for raising funds for one or more schools.

2. Background of the Invention

Communities have continuously borne the burden of supporting school programs through meaningful action. When state governments assumed a larger role of funding public education, schools joined with the community and businesses to raise money for special activities not covered under school budgets. The community and local businesses organized fund-raising events, donated items to the school, held raffles, or baked cakes. To increase revenue and give students a sense of ownership in fund-raising efforts, schools began selling everything from candles and candy, to wrapping paper and holiday greeting cards through door-to-door solicitation. Parents, relatives, and neighbors were prevailed upon to buy sometimes unwanted and oftentimes unnecessary products as a way to support their local school. Despite the negative aspects, student sales provided a way to generate extra money for special activity funds.

Additionally, recent incidents have shown that the world has become a more dangerous place, especially for children. In 1997, an 11-year-old boy was killed as he was selling wrapping paper and candy in his suburban New Jersey neighborhood. The National PTA has taken a negative position on children knocking on strangers' doors. The National Association of Fund Raisers issued a statement saying it does not endorse door-to-door sales. Some school districts have banned fund raising through door-to-door solicitation. Recently, a child in Houston, Tex. was shot while selling candy in his neighborhood. Clearly, times have changed, even though the need to raise money has not disappeared. Even though school budget deficits have increased the need to raise funds for special activities, some state legislatures are considering reductions in school funding. Revenues from conventional fund raisers cannot alone meet needs not covered in the school budget.

A growing number of school districts around the country are resorting to a controversial source of funding: they are selling naming rights and advertising space. Some school districts put the names of companies or “donors” on items ranging from book covers to buildings. Additionally, in others, advertising space is available on school buses, on school roofs near airports, and on uniforms, gym walls, and sports fields. Even more controversial are exclusive vending machine contracts with schools to sell soft drinks and snacks to children and free curriculum materials with embedded advertising.

### SUMMARY OF THE INVENTION

With the foregoing in mind, embodiments of the present invention advantageously addresses the issue of how schools can raise sufficient funds without endangering students or employing objectionable forms of advertising. Embodiments of the present invention, advantageously provides a system, software, program products, and associated methods to provide schools with a continuous stream of revenue that does not put children in harm's way and offers services that the community really needs and wants. Embodiments of the present inventive system, software, and method have significant advantages for all participants. These embodiments of a fundraising program, for example, provide a continuous income stream for schools and districts; protect children from unsafe solicitation activities; deliver services the community needs and wants; helps businesses attract new customers; and enhance the image of companies in the community.

In embodiments of the present inventive system, software, and methods, for example, vendors or businesses and a system server computer work with school districts to develop a program of products and services that the community wants and needs. The schools can agree to promote the products and services within the local communities. Companies advantageously agree to return a monthly or quarterly revenue, based on earned income from the services to new or renewing customers, to individual schools, and districts. Income may be generated in the form of percentages of monthly sales, flat amounts added on as monthly fees to support the school, or amounts contributed by the customer and matched on a percentage basis by the company.

According to embodiments of a method of fundraising of the present invention, from individuals signing up to support their local schools, to income collection, and to fund distribution to specific districts, the entire process advantageously can be managed electronically. Districts receive monthly or quarterly statements of their accounts at clearing banks. Through the present invention, schools have the capability of developing a continuing flow of income to help them better serve their students and the community. Companies have the capability through embodiments of the present invention to increase their customer base and form closer links with the community by supporting schools. Through embodiments of the present invention, the community can support their schools through the use of products and services that are needed and desired.

One embodiment of the present invention is a charitable contributions system. The system including, but not limited to, an administrator server having a server computer to access a server database to store preselected charity information for each of a plurality of participant primary and secondary schools, and server memory including fundraising software stored therein. The fundraising software including a school identifier to identify a specific designator differentiating each participant primary and secondary school from a plurality of participant primary and secondary schools, a school designator provider to provide the specific designator for at least one of the participant schools to the consumer, a vendor informer to inform the consumers of which vendors within a community are participant vendors, and a vendor tracker to track sales incentives provided and transactions reported by each participant vendor so that each participant school and consumer has information on the total money raised for each participant school from each participant vendor. The system also including a plurality of vendor computers in communication with the administrator server through the communication network. Each of the vendor computers having access to a vendor database to store preselected transactional information, and having vendor memory including vendor software stored therein. The vendor software including a participant tagger to tag and associate at least one school designator selected by a consumer with a sales transaction between the consumer and a participant vendor, a donation recorder to determine and record a monetary value to distribute to the selected participant school represented by the school designator, a donation disburser to disburse a disbursement of money associated by the school designator over the communication network, and a vendor reporter to report sales incentives and disbursements of money associated by the school designator over the communication network.

Another embodiment of the present invention is a method for charitable contributions. The method includes but is not limited to, enrolling a plurality of primary and secondary schools and vendors as participants in a charitable program. The method also includes providing each of the participant plurality of primary and secondary schools a designator to identify each particular primary and secondary school participating in the charitable program. The method also includes attaching at least one designator to transactions by each of the plurality of participant vendors. The method also includes providing a sales incentive for each of the transactions having at least one designator attached thereto. The method further includes reporting the sales incentives provided and transactions with at least one participant school attached thereto reported by the vendor to an administrative server.

Yet another embodiment of the present invention is software or program product for charitable contributions. The software, for example, includes but is not limited to, a school identifier to identify a specific designator differentiating each participant primary and secondary school from a plurality of participant primary and secondary schools. The software also includes a school designator provider to provide the specific designator for at least one of the participant schools when a contributor identifies the at least one of the participant schools. The software also includes a vendor informer to inform the contributor of participant vendors, so that the possible contributor has information on which vendors within a community are participant vendors providing sales incentives benefiting the participant schools. The software further includes a vendor tracker to track sales incentives provided and transactions reported by each participant vendor so that each participant school and contributor has information on the total money raised for each participant school from each participant vendor.

Yet other embodiments of the present invention also include a computer readable medium that is readable by a computer, the computer readable medium comprising a set of instructions that, when executed by the computer, cause the computer to perform the following operations to collect charitable contributions. The operations include, but not limited to, enrolling a plurality of primary and secondary schools and vendors as participants in a charitable program. The operations also include providing each of the participant plurality of primary and secondary schools a designator to identify each particular primary and secondary school participating in the charitable program. The operations further include tracking sales transactions of each of the plurality of participant vendors and having at least one designator attached to the transactions. The operations include providing a sales incentive for each of the transactions having at least one designator attached thereto. The operations further include reporting the sales incentives provided and transactions with at least one participant school attached thereto reported by the vendor to an administrative server.

Embodiments of the present invention still also include a computer memory element containing stored in signal bearing media a database. The database containing data in computer-readable format. The data including, but limited to, a state, a city, and a school district for each of the participant primary and secondary schools. The data including the promotional sales incentives offered by each of the participant vendors. The data further including a tally of donations made to each participant school sorted by school designator and sorted by the promotional sales incentives.

The fundraising system, software, program products, and associated methods of the present invention advantageously provide a way for schools to raise monies for various school programs without having the students of the schools going door to door to members of society that are unknown to each of the students. The fundraising system also provides a way of raising money that does not force the community to purchase various goods from particular vendors and retailers providing goods from which those in the community might not have any needs or desires. Rather, the supporter in the fundraising system can choose from the vendor's goods and services that the supporter desires. The fundraising system also provides a way for discounts to be afforded to supporters shopping for goods, like school supplies and clothes, for the students. Means of affording discounts can include vouchers and coupons to be redeemed during a purchase, or simple reduction in prices by set percentages off of goods purchased for the benefit of the students. Additionally, the fundraising system provides a manner through which the vendor within a particular community can show their support of participant schools in the community and associated goodwill within such community. Finally, participant schools can draw attention to particular vendors among registered and prospectively registered supporter in a dignified manner of asking participant supporter to consider transactions with the participant vendors, rather than providing advertising space on school properties, and appearing to have an endorsement of particular vendors 611 with the school property.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a schematic diagram of a fundraising system and method for raising funds according to an embodiment of the present invention;

FIG. 2 is a schematic flow diagram of software for a school designator provider program in a fundraising system shown in FIG. 1 according to an embodiment of the present invention; and

FIGS. 3A-3B are schematic flow diagrams of a process through which funds are raised with a fundraising system shown in FIG. 1 according to an embodiment of the present invention.

### DETAILED DESCRIPTION OF THE PREFERRED EMBODIMENT

The present invention will now be described more fully hereinafter with reference to the accompanying drawings, in which illustrated embodiments of the invention are shown. This invention may, however, be embodied in many different forms and should not be construed as limited to the illustrated embodiments set forth herein. Rather, these illustrated embodiments are provided so that the disclosure will be thorough and complete, and will fully convey the scope of the invention to those skilled in the art. Like numbers refer to like elements throughout, and prime and double prime notation, if used, indicate similar elements in alternative embodiments.

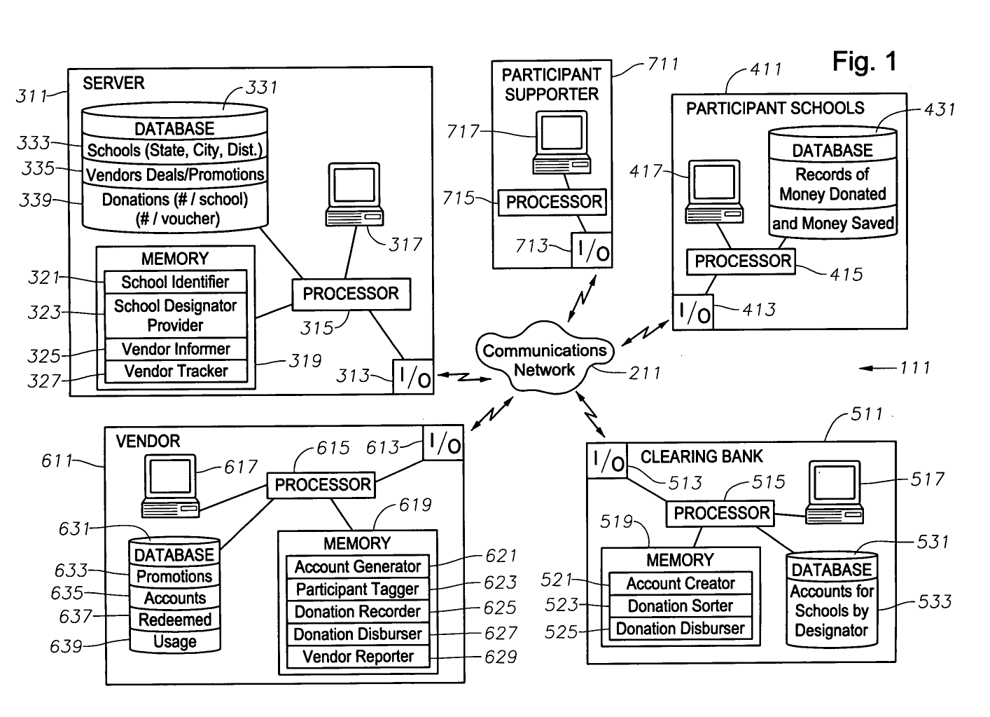

FIG. 1 illustrates how an embodiment of a charitable contribution or fundraising system 111 of the present invention uses today's technology to raise funds for charitable programs such as primary and secondary schools. The fundraising system 111 preferably includes a communication network 211 which advantageously provides an electronic conduit between different aspects and participants of the fundraising system 111. The communication network 211 is preferably an electronic communication system like the Internet. The fundraising system 111 includes an administrator server 311 which advantageously communicates with communication network 211 for raising funds. Primary and secondary educational schools 411 wishing to raise funds through the fundraising system 111 advantageously use the communication network 211 to communicate with the administrator server 311. A clearing bank 511, which collects and disburses funds that are raised through the fundraising system 111, advantageously uses the communication network 211 to communicate with the administrator server 311 and transfers funds to participant schools 411.

Preferably, a plurality of vendors 611 choose to participate in the fundraising system 111. Each participant vendor 611 advantageously uses the communication network 211 to communicate with the administrator server 311 and to transfer funds to the clearing bank 511. A plurality of consumers wishing to participate, or supporters 711, preferably utilize the communication network 211 to sign up as a supporter of the fundraising system 111 by using access to the administrator server 311 to participate in the fundraising system 111 to raise money for the participant schools 411.

The participant schools 411 communicate with the communication network 211 through input/output communicating means such as provided by a school input/output interface 413. The school input/output interface 413 advantageously provides a way for participant schools 411 to communicate through the communication network 211 with the administrator server 311 and the clearing banks 511. The school input/output interface 413 can be any device or apparatus for communicating electronically with the communication network 211. For example, the school input/output interface 413 can advantageously be a modem, a cable Internet connection, a DSL Internet connection, or any other known device for communicating through the Internet as understood by those skilled in the art. The participant schools 411 preferably include a school processor 415 for transmitting and receiving electrical signals, through the school input/output interface 413, to and from the communication network 211. The school processor 415, for example, can be a central processing unit found within a computer at each of the participant schools 411.

School user communicating interface means, such as provided by a school user interface 417, advantageously provides a device or apparatus for communicating between an individual at each of the participant schools 411 and the communication network 211 through the processor 415 and the school input/output interface 413. Although the school user interface 417 is shown in FIG. 1 as a monitor and a keyboard, the school user interface 417 can also be any other known apparatus through which an individual can communicate with the Internet. For example, a school user interface 417 can include, but is not limited to, a mouse attached to a computer within school 411, a personal digital assistant (PDA), a cellular telephone with Internet connections, or a touch sensitive screen connected to a computer system having access with communication network 211. The participant schools 411 preferably also include a database 431, which is in electrical communication with processor 415. The database 431 advantageously stores accessible records of money saved 433 or money donated 435 to the participant school 411 through the use of fundraising system 111.

The administrator server 311 preferably also includes server input/output communicating means, such as a server input/output interface 313, for communicating with the communication network 211. The server input/output interface 313, like the school input/output interface 413, can be any known way of communicating with the Internet or the communication network 211. For example, the server input/output interface 313 can include, but not be limited to, a dial up or other modem, a LAN communication system, a DSL or a cable internet connection. The administrator server 311 preferably includes a processor 315 that is in communication with the server input/output interface 313. The server processor 315 is typically a central processing unit of a computer system for the administrator server 311. The server processor 315 preferably provides a website through which the participant schools 411, the clearing banks 511, the vendors 611, and the supporters 711 can interface with the administrator server 311 through the communication network 211.

The administrator server 311 preferably also includes server user interface 317 which is in communication with the server processor 315 for viewing and transmitting signals to and from the communication network 211 through the server input/output interface 313 and the processor 315. Although the server user interface 317 is shown in FIG. 1 as a monitor with a keyboard, it should be readily apparent to those skilled the art that the server user interface 317 can be any known device or apparatus through which an individual can communicate with the Internet or communication network 211. The server user interface 317 can preferably include, but not be limited to, any of the devices or apparatuses listed above as possible a school interface 417 at the participant schools 411.

The administrator server 311 preferably also includes a server memory 319 which is in communication with the server processor 315. The server memory 319 preferably includes software for performing various tasks required of the administrator server 311 within the fundraising system 111. As will be readily appreciated by those skilled in the art, the server memory may also preferably include a program product for performing various tasks required of the administrator server 311 within the fundraising system 111. The server memory 319 preferably includes, but is not limited to, software or a program product for a school identifier 321, a school designator provider 323, a vendor informer 325, and a vendor tracker 327. The school identifier 321 advantageously creates and identifies a particular school with a unique and particular designator after the participant school 411 registers with the administrator server 311 through the communication network 211 as a school interested in using the fundraising system 111 for raising funds for school programs. In one embodiment, the school identifier includes a school numberer that creates a unique number for each participant school 411 registering with the fundraising system 111 as the unique designator.

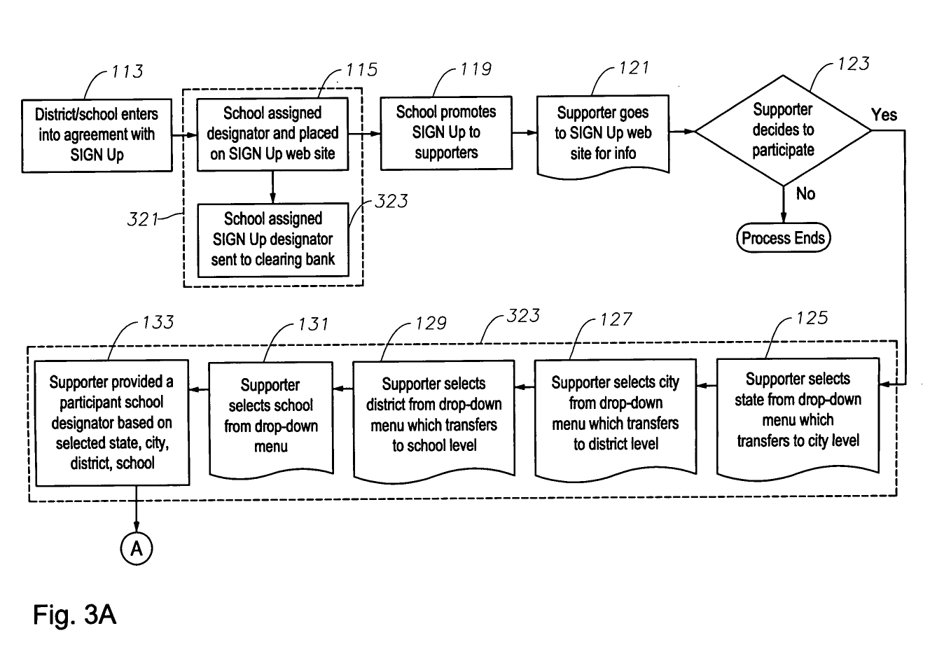

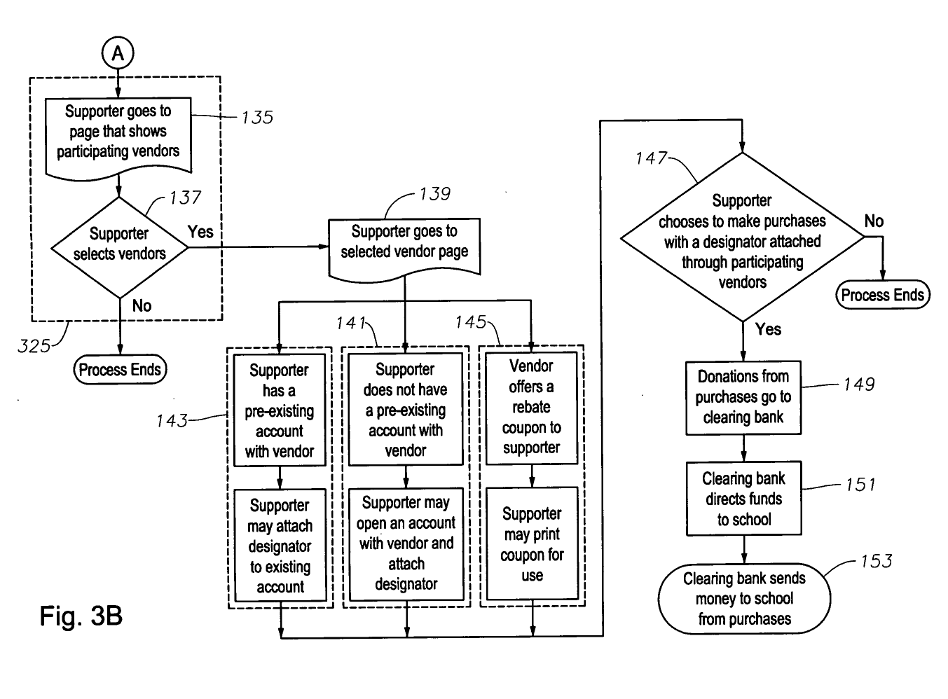

The school designator provider 323 advantageously provides software to retrieve and transmit to the supporter 711 a school designator for each participant school 411 that is raising money through the fundraising system 111. The school designator provider 323 advantageously provides across the communication network 211, the school designator generated by the school identifier 321 for each of the participant schools 411 that the supporter 711 has selected as a beneficiary in the fundraising system 111. The process of providing a designator to each participant supporter 711 is illustrated in more detail in FIG. 3, which is discussed in more detail herein below.

The server memory 319 preferably also includes the vendor informer 325 which advantageously provides a manner of communicating to the participant schools 411 and the participant supporters 711 which vendors 611 are participating in the fundraising system 111. By providing which vendors 611 are participating in the fundraising system 111 to the participant supporters 711 and the participant schools 411, the participant schools 411 can communicate to the community which vendors 611 are making donations to the participant schools 411 through the ftundraising system 111 to help generate more funds which are raised through the fundraising system 111. Additionally, the participant supporters 711 will also be more aware of which vendors are trying to help raise money for the participant schools 411 which, in turn, can provide a motivating factor for the participant supporter to go to the participant vendor 611 for goods or services provided by the vendor 611.

The server memory 319 preferably also includes the vendor tracker 327 which advantageously provides a manner of communicating to the participant schools 411 and the participant supporters 711 information on the total money raised for each participant school 411 from each participant vendor 611. The vendor tracker 327 tracks sales incentives provided by the participant vendors and the transactions reported by each participant vendor 611. The sales incentives tracked by the vendor tracker 327 can include donations of a certain percent from the total price of a purchase, donations of a set dollar amount for every purchase, or a set way of reducing a sales price for the supporter 711 purchasing goods for students. Examples of ways the participant vendor 611 can reduce sales prices are with rebates, vouchers, and sales have a percent reduction in price.

The administrator server 311 preferably also includes a database 331 in communication with the processor 315 for storing information that can be valuable for use by the various programs in the memory 319 for communication with the supporters 711, the participant schools 411, the clearing banks 511, and the vendors 611 participating in the fundraising system 111. For example, the database 311 can store school information 333. School information 333 preferably includes such logistical data as the state, city, and school district in which the participant school 411 is located. As will be appreciated to those skilled in the art upon a more detailed discussion of the school designator provider 323 in FIG. 3, the school designator provider 323 can have access to the school information 333 and the database 331 in order to properly sign up a participant supporter 711 through the communication network 211 in the fundraising system 111.

The database 331 preferably also includes vendor information 335. The vendor information 335 preferably includes information displayed on the web page of the administrator server 311 by the vendor informer 325 and communicated through the communication network 211 to the participant schools 411 and the participant supporters 711 registered in the fundraising system 111. Information typically stored in the vendor information 335 of the server database 331, for example, can include such information as promotional sales incentives and deals that are setup between the administrator server 311 and the vendors 611 for contributions to the participant schools 411 within the fundraising system 111. The promotions and deals preferably include any manner in which the vendors 611 believe they can donate monies to the participant schools 411 which include, but are not limited to, accepting predetermined dollar amounts added to bills for services provided, donating a portion of each purchase to the participant schools 411, donating a specific amount per participant supporter 711 making a purchase with a redeemable coupon, or merely providing a better or reduced price for parents and participant supporters 711 within the community to help students at a participant school 411 purchase supplies or clothes that are necessary for school.

The server database 331 preferably also stores information on the schools 411 selected by each of the participant supporters 711. For example, as each of the participant supporters 711 receives a school designator through the school designator provider 323, the school designator provider 323 transmits information to the database 331. Typical information stored within the server database 331 about the participant supporters 711 selection includes, but is not limited to, an incremental count as to which schools the participant supporter 711 selected out of the participant schools 411.

The server database 331 also preferably stores donation data 339 pertaining to the fundraising system 111 and is retrievable by the vendor tracker 327. The typical donation data stored within the server database 331 includes, but is not limited to, the amount donated to each participant school 411 and the amount of money donated from each participant vendor 611 through the fundraising system 111. For example, the information on the amount of monies donated to each of the participant schools 411 and the amount of money donated from each of the participant vendors 611 is communicated through communication network 211 from the clearing bank 511. The statistical information found in the donation data 339 can advantageously be used by the server to provide information to the participant schools 411, the participant supporters 711, and the vendors 611, through the communication network 211 to show how the fundraising system 111 is working within the community to raise or save money for the participant school 411 and their students through the efforts of the participant supporters 711 and the vendors 611.

The vendor 611 preferably communicates with communication network 211 through a vendor input/output interface 613. The vendor input/output interface 613, like the server input/output interface 313, the school input/output interface 413 can preferably be any known system or apparatus for communication with the communication network 211. The vendor 611 preferably also includes a vendor computer or processor 615 that is in communication with the communication network 211 through the vendor input/output interface 613. The vendor processor 615 is preferably in communication with a vendor-user interface 617, the vendor memory 619, and a vendor database 631. The vendor-user interface 617, although shown as a monitor and keyboard in FIG. 1, can be any known device or apparatus for communicating with the Internet and the communication network 211 through vendor processor 615. The vendor memory 619 preferably has programs and/or software for performing specific tasks that would be required within the fundraising system 111 stored therein.

The vendor memory 619 preferably has software of an account generator 621 for advantageously providing an internal system of maintaining customer records within the community of the vendor 611 stored therein. The account generator 621 is preferably software that is known in the art for vendors to assign internal numbers to particular customers for the record keeping purposes. For example, the account generator 621 can be software for a utility company to assign an account number to a customer receiving electrical power from the utility company, or the account generator can be used by a vendor to create a credit account number for a customer wishing to extend a line of credit with the vendor 611. The account generator 621 preferably creates and provides an account number to customers within the community of the vendor 611 in a manner desirous for the particular needs of each vendor 611.

The vendor memory 619 preferably also includes a participant tagger 623 to attach to an account generated by the account generator 621 the school designator from a participant supporter 711 created by school identifier 321 and provided by the school designator provider 323. The participant tagger 623 can assign the school designator from the participant supporter 711 to an existing account of the vendor 611 or an account being concurrently created with the account generator 621. The accounts generated by the account generator 621, and the accounts that are tagged by participant tagger 623, are preferably communicated through vendor processor 615 to vendor database 631 and stored in vendor tagged accounts 635.

The vendor memory 619 also preferably includes a vendor donation recorder 625. The vendor donation recorder 625 advantageously records of each purchase or coupon redeemed under the promotions or deals offered by the vendor 611 to the participant supporters 711. The vendor donation recorder 625 also advantageously communicates each purchase, percent discount, coupon receipt, and donation attached to payment for services provided from the participant supporter 711 to the vendor 611, through the vendor processor 615 to the vendor database 631. The records of each donation made from the transaction between the participant supporter 711 with the vendor 611 is stored in the vendor database 631 for later access by a donation disburser 627 within the memory 619 of the vendor 611. The donation disburser 627 accesses the vendor database 631 through the vendor processor 615. The donation disburser 627 calculates the amount of money to be donated by the vendor 611 to each participant school 411. The donation disburser 627 also transmits through the communication network 211 the donations to the clearing bank 511 for disbursement to the participant schools 411.

The vendor memory 619 preferably also includes a vendor reporter 629 to report the sales incentives and disbursements of money associated by the school designator over the communication network to the administrator server 311. The vendor reporter 629 retrieves from the vendor database 631 and communicates to the administrator server 311, each purchase, percent discount, coupon receipt, and donation attached to payment for services provided from the participant supporter 711 to the vendor 611. The vendor reporter 629 preferably also reports the amount of money be donated by the vendor 611 to each participant school 411 from the donation disburser 627.

The vendor database 631 preferably stores information such as the tagged accounts 635 from each participant supporter 711 with the vendor 611, the promotions 633 or redeemed discounts and coupons 637 that are taken advantage of by the participant supporters 711, and an overall usage 639 with the vendor 611 from participant supporters 711 of the fundraising system 111. The statistical information stored within the vendor database 631 advantageously provides the vendor 611 with data to show what promotional sales incentives the participant supporters 711 are utilizing for saving money for student expenses and raising money for the participant schools 411 with the fundraising system 111. The database 631 also advantageously provides overall historical background for the vendor 611 to appreciate additional business created with participant supporter 711 through the fundraising system 111.

The clearing bank 511 preferably has a bank input/output interface 513, a bank computer or processor 515, and bank-user interface 517 for the bank 511 to communicate with the administrator server 311, the participant schools 411, and the vendors 611 through the communication network 211. Preferably, the bank input/output interface 513, the bank processor 515, and bank-user interface 517 are substantially similar to the input/output interface 413, 313, 613, processors 313, 413, 613, and user interface 417, 317, 617 of the participant schools 411, the administrator server 311, and the vendors 611.

The bank 511 preferably also includes a bank memory 519 having software stored therein to perform specific tasks necessary for the fundraising system 111. For example, the bank memory 519 preferably includes a bank account creator 521 for creating specific accounts for receiving money and disbursing money to the participant schools 411. The account creator 521 can advantageously be any system or software generally known in the art for creating new accounts for a customer. Each account, however, is specifically designated for each of the participant schools 411 and provided to clearing bank 511 from the administrator server 311 through the communication network 211. The bank memory 519 also preferably includes a donation sorter 523 for determining which monies transmitted from the vendors 611 should disbursed to the various accounts created by the account creator 521 for each of the participant schools 411. The bank memory 519 also preferably includes a donation disburser 527 to dispense each of the monies sorted by the donation sorter 523 to each of the accounts created by the account creator 521 for each of the participant schools 411. The account creator 521, the donation sorter 523, and the donation disburser 527, for example, can all be selected from those generally known in the art of financial institutions and utilized by the clearing bank 511.

The clearing bank 511 also preferably includes a bank database 531 in communication with the bank processor 515. The bank database 531 preferably stores the account numbers created by the account creator 521 for each of the participant schools 411, and the amount of money donated to each of the participant schools 411 within each of the accounts 533 stored within the bank database 531. The account information 533 is preferably readily accessible through the communication network 211 by the participant schools 411 for money transfers and withdrawals, and record keeping of how much money has been donated and accumulated in the account 533 for that particular participant school 411. The amount of money disbursed within each of the school accounts 533 is also preferably accessible by the administrator server 311 through the communication network 211, for the participant supporter 711 and the vendor 611 to monitor the progress of the fundraising system 111. Publication by the administrator server 311 of the amount of money donated to each of the participant schools 411 through the communication network 211 to the participant supporters 711, the vendors 611, and possible future participant schools 411, advantageously provides a marketing tool through which more fundraising activities can be utilized with the fundraising system 111.

The participant supporter 711 preferably includes a supporter input/output interface 713 for communication with the communication network 211. The supporter input/output interface 713, like input/output interface 513, 613, 313, and 413, can be provided by any device or apparatus known in the art for communicating with the internet and communication network 211. The participant supporter 711 preferably receives and transmits signals through supporter input/output interface 713 with a supporter processor 715. The supporter 711 preferably receives and communicates signals to the supporter processor with supporter-user interface 717. The participant supporter 711 preferably registers with the administrator server 311 through the communication network 211 by utilizing supporter-user interface 717, the supporter processor 715, and the supporter input/output interface 713.

The participant supporter 711 also preferably conducts the activities necessary for making contributions and donations to the participant schools 411 through the vendors 611 over the communication network 211. The participant supporter 711 preferably has access through the communication network 211 to the administrator server 311 for reviewing the amounts of donations provided to the school 411 selected by the participant supporter 711 through the communication network 211. By having various ways of using the communication network 211 for the supporter 711 to monitor and receive information as to how much money is donated to the selected participant school 411 of the participant supporter 711, the fundraising system 111 advantageously provides a system through which the participant supporter 711 continues to conduct activities with the vendors 611 that are donating money to the participant schools 411 through the fundraising system 111.

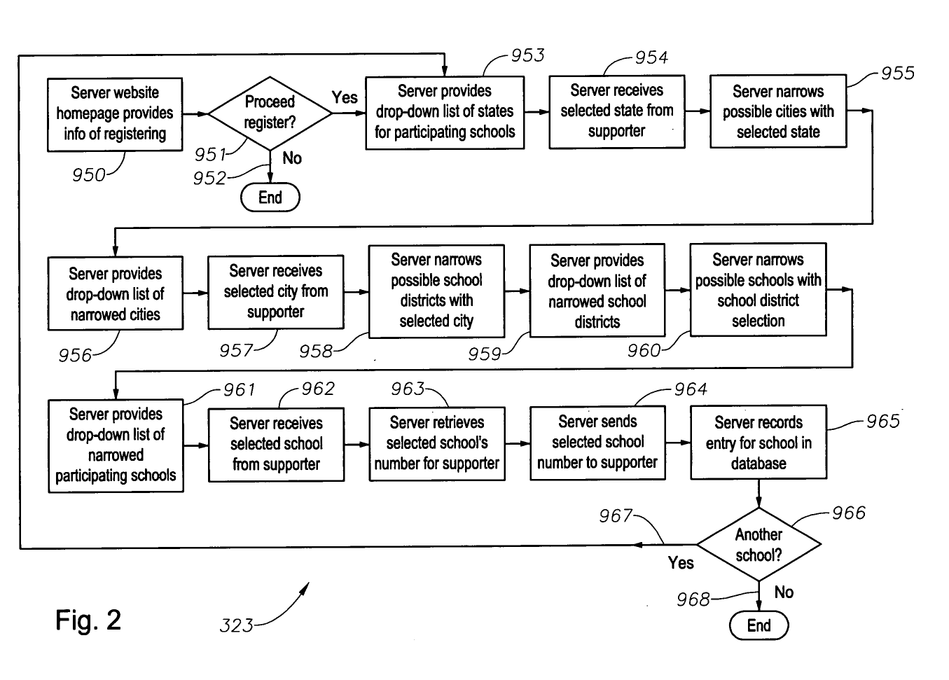

FIG. 2 illustrates an embodiment of software or program product for the school designator provider 323 in the administrator server 311. In operation, a participant supporter 711 enters the website of the administrator server 311 through the communication network 211. The supporter 711 views the server website home page 950 of administrator server 311, which provides information on the fundraising system 111 and the vendors 611. The participant supporter 711 decides whether to proceed with registration in the fundraising system 111 through the administrator server 311. If the participant supporter 711 decides not to register with the administrator server 311, the school designator provider software 323 ends 952. If the participant supporter 711 decides to continue registration with the administrator server 311, the school designator provider software 323 then accesses the server database 333 and provides the schools 411, starting with a state provider 953, with school designator provider software 323.

The states in which the participant schools 411 are located can be provided to the participant supporter 711 through the web page of the administrator server 311 in numerous forms. For example, the states can be listed as a hyperlink, so that selection of each state then transmits the participant supporter 711 to the next step of the school designator provider program 323. Alternatively, the state provider 953 can also provide the states in a drop down menu or list of states for which the participant schools 411 are located. The states in which the participant schools 411 are located are transmitted through the communication network 211 to the participant supporter 711, who then selects the state of the participant school 411 which the participant supporter 711 wishes to support. The administrator server 311 receives the selected state 954 from the supporter 711 through the communication network 211. The school designator provider program 323 then utilizes a city narrower 955 to narrow the possible cities in which the participant school 411 may be located based upon the state provided. The school designator provider 323 provides the cities in which participant schools are located for the selected state selected from state provider 953, with city provider 956. The city provider 956 supplies the cities from which the participant supporter 711 can select from any generally known and accepted form, such as drop down lists, hyperlinks, or a map with locations within the state for selection from the participant supporter 711.

The administrator server 311 receives the selected city 957 from the participant supporter 711 through the communication network 211. A school district narrower 958 of the school designator provider program 323 narrows the possible school districts within the selected state and cities from the participant supporter 711. The school designator provider program 323 then uses a school district provider 959 to communicate the possible school districts in which participant schools 411 are located to the participant supporter 711. The school districts are provided to the participant supporter 711 through the communication network 211 by the administrator server 311 with the school district provider 959 of the school designator provider program 323. The administrator server 311 advantageously receives the selected school district from the list of school districts provided by school district provider 959 from the communication network 211 and the participant supporter 711.

The administrator server 311 then uses a school narrower 960 as part of the school designator provider program 323 for narrowing the participant schools 411 for the participant supporter 711 to choose from based upon the selected state, city and school districts. The school designator provider program 323 then provides, with a school provider 961, the possible participant schools 411 for the supporter 711 to choose from. The school provider 961 can provide the participant schools 411 to the participant supporter 711 over the communication network 211 in a variety of forms for the participant supporter 711 to select, such as a drop down list or listed as independent hyperlinks. The administrator server 311 receives 962 the selected school 411 from the participant supporter 711 over the communication network 211.

The school designator provider 323 then uses a designator retriever 963 to search for, and locate the school designator for the newly selected school 411 that was previously generated by school identifier 321 and stored in database 333. After the designator retriever 963 retrieves the school designator for the selected school 411, a designator transmitter 964 sends the selected school's 411 school designator to the supporter 711 over the network 211. The participant supporter 711 provides the school designator sent with designator transmitter 964 to vendors 611 during transactions for the selected participant school 411 to receive donations from the vendors 611. The school designator provider 323 then transmits an incremental record 965 to the server database 331 of which school 411 was selected by the participant 711.

At this point, the school designator provider program 323 asks the participant supporter 711 over the communication network 211 whether the participant supporter 711 desires to designate a second or another 966 participant school 411 for which donations should be dispensed to through the fundraising system 111. If participant supporter 711 desires to designate 967 an additional participant school 411, the school designator provider program 323 redirects the participant supporter back to the state provider 953 for the initial selection stages of an additional participant school 411. The participant supporter 711 continues to select states, cities, school districts, and participant schools 411 from the provided states, cities, school districts, and schools until the participant supporter 711 has designated and received school designators for all the participant schools 411 the participant supporter 711 wants to support. After the participant supporter 711 receives the school designators for each of the schools 411 the supporter 711 would like to support, the programs ends when supporter answers “no” when asked whether the participant supporter 711 desires to designate an additional participant school 968.

FIGS. 3A-3B illustrate an embodiment of an overall system or process by which funds are raised through fundraising system 111. In practice, a school desiring to enter the fundraising system 111 enters into a fundraising agreement 113 through the administrator server 311 for listing on the web page of the administrator server 311. The school identifier 321 assigns the appropriate school designator 115 to the school wishing to become a participant school 411 in the fund raising system 111. Upon assigning a school designator to the newly registered participant school 411, the administrator server 311 transmits 117 the newly registered participant school 411 to the clearing bank 511 which then uses account creator 521 to create an account for money raised to be deposited.

The participant school 411 informs and promotes 119 to its students, parents, and general community that it is signed up with the fundraising system 111. The participant school 411 preferably provides the students, parents, and general community with the web site of the administrator server 311 for the parents and community members to register as participant supporters 711. Parents, relatives, and members of the community preferably visit the web site 121 of the administrator server 311 and decide to participate 123 in the fund raising system 111. After registering, the parents, relatives, and community member become participant supporters 711, who are provided school designators through the school designator provider program 323 as described above. The prospective participant supporter 711 provides the state 125, city 127, school district 129, and particular school 131 of participant schools 411 for which the prospective participant supporter 711 desires to donate money to. The school designator provider 323 then provides a designator 133 to newly registered participant supporter 711 in the manner described above. The participant supporter 711 can view information 135 about participant vendors 611 on the web site of the administrator server 311 through the vendor informer program 325. If the registered supporter 711 decides to proceed with transactions with the participant vendor 611, the participant supporter 711 selects 137 at least one of the participant vendors 611 from the vendor information provided by the administrator server 311. Selecting a particular participant vendor 611 then connects 139 the participant supporter 711 with the participant vendor 611 through the communication network 211.

Depending upon the donation system or arrangement agreed to between the administrator server 311 and the participant vendor 611, the participant supporter 711 has a variety of ways of supporting the participant school 411 with activity through the vendor 611. For example, if the vendor 611 has committed to donating a percentage of each purchase from participant supporter 711 with the vendor 611, the participant supporter 711 can ask to have the designator generated by school designator provider 323 attached to a newly registered account 141 created by 621 or an existing account 143, found in the vendor database 631 with the participant tagger 623. Alternatively, if the vendor has offered a rebate or coupon 145 that is redeemable by participant supporter 711, the participant supporter 711 can provide the designator generated by the school designator provider 323 of the vendor 311 to the participant vendor 611 to receive and/or redeem a rebate on goods or services provided by the vendor 611 in the fundraising system 111. Further, in the case of utilities or cable providers who enter into special arrangements with the administrator server 311, the participant supporter 711 can provide the designator generated by school designator provider 323 and make a pledge for a preselected amount to be donated to the participant schools 411 with each bill for services provided by the vendor 611.

The participant supporter 711 chooses 147 to make purchases through the participating vendors 611, either at the vendor website or at a physical store location. The donation recorder 625 monitors and records all transactions made by a participant supporter 711 that has provided the designator generated by school designator provider 323 to a vendor 611. The donation recorder 625 preferably transmits all data through the vendor processor 615 to the vendor database 631 for storage within the specific storage units pertaining to promotions 623, accounts 625, and redeemed rebates/coupons 637. The vendor donation disburser 627 then retrieves all information from the vendor database 631 dealing with monies recorded within promotion 633, accounts 635 and redeemed rebates/coupons 637, and transmits 149 deposits to the clearing bank 511 through the communication network 211. The donation recorder 625 preferably keeps track of how much money is designated for each participant school 411 so that the funds being transmitted to clearing bank 511 are easily segregated and disbursed within the various accounts for participant schools 411.

Upon receiving fund transfers from participant vendor 611, the clearing bank 511 uses the donation sorter 523 and donation disburser 527 to direct or segregate 151 and deposit the various monies from the participant vendors 611 to the accounts 533 for each of the participant schools 411. The information and amounts of each deposit into the accounts 533 are preferably stored within the bank database 531 and easily accessible through the communication network 211 by each of the participant schools 411 and the administrator server 311 for advertising and promotional purposes. The clearing bank 511 then sends the money 153 in a particular participant school's 411 account 533 pursuant to a withdrawal by the participant school 411.

The fundraising system 111, as illustrated and described herein, advantageously provides a way for schools to raise monies for various school programs without having the students of the schools going door to door to members of society that are unknown to each of the students. The fundraising system 111 also provides a way of raising money that does not force the community to purchase various goods from particular vendors and retailers providing goods from which those in the community might not have any needs or desires. Rather, the supporter 711 in the fundraising system 111 can choose from vendor 611 for goods and services that the supporter 711 desires. Additionally, the fundraising system 111 provides a manner through which the vendor 611 within a particular community can show their support of participant schools 411 in the community and associated goodwill within such community. Finally, participant schools 411 can draw attention to particular vendors 611 among registered and prospectively registered supporter 711 in a dignified manner of asking participant supporter 711 to consider transactions with the participant vendors 611, rather than providing advertising space on school properties, and appearing to have an endorsement of particular vendors 611 with the school property.

The fundraising system 111 as described and illustrated herein advantageously provides a system through which relatives and friends, who are not located in the general community surrounding a participant school 411, can show support for relatives and friends by registering as a participant supporter 711 and designating a distant participant school 411 through the communication network 211 and administrator server 311. The fundraising system 111 advantageously provides a manner for distant relatives to show support of participant schools 411 for which their relatives are students by purchasing goods from participant vendors 611 over the Internet, communication network 211 from participant vendors 611, or from participant vendors 611 that are within their own general community.

Embodiments of the present invention include a method for charitable contributions. The method includes, but is not limited to, providing a plurality of participant primary and secondary schools 411 that been engaged for participation in a charitable program 111 for benefit of each of the plurality of participant schools 111 and students of each of the participant schools 411. Each of the participant schools 411 have a school designator to differentiate the participant school 411 from the remainder of the plurality of participant primary or secondary schools 411.

The method also includes providing a plurality of participant vendors 611 that have been engaged for participation in the charitable program 111. Each of the plurality of participant vendors 611 have a vendor computer 615 in communication with a communication network 211. The vendor computer 615 having access to a vendor database 631 to store information regarding promotional sales incentives 633 offered by the participant vendor 611, usage 639 of the promotional sales incentives, consumer accounts 635 having school designators associated therewith, and redemption 637 of the promotional sales incentives. The vendor computer also has vendor memory 619 that include vendor software stored therein. The vendor software includes an account generator 621 to create a customer account associated with each applying consumer, a participant tagger 623 to tag and associate at least one school designator selected by the consumer or participant supporter 711 with the customer account for each sales transaction between the consumer 711 and the participant vendor 611, a donation recorder 625 to determine and record a monetary value to distribute to the selected participant school 411 represented by the school designator, a donation disburser 627 to disburse a disbursement of money associated by the school designator over the communication network 211, and a vendor reporter 629 to report sales incentives and disbursements of money associated by the school designator over the communication network 211. The method also includes providing a clearing bank 511 in communication with the communication network 211. The clearing bank 511 having a clearing bank computer 515 having access to a clearing bank database 531 to store information regarding deposits, withdrawals, and interest earned over time for each bank account created for each participant school 411. The clearing bank computer 515 also having clearing bank memory 519, which includes clearing bank software stored therein. The clearing bank software has an account creator 521 to create a bank account for each participant school 411 having a school designator, a donation sorter 523 to identify a monetary value associated with each participant school 411 in disbursements from each participant vendor 611, and a donation distributor 525 to deposit said monetary value in the bank account created for each participant school 411 by the account creator. The method also includes providing an administrator server 331 in communication with communication network 211. The administrator server 211 having a server computer 315 to access a server database 331 to store information retrievable through the server 311 via the communication network 211. The information including a state, a city, and school district 333 for each of the participant primary and secondary schools 411. The information including the promotional sales incentives 335 offered by each of the participant vendors 611. The information including a tally of donations 339 made to each participant school 411 sorted by school designator and sorted by the promotional sales incentives. The vendor computer has server memory 319 including fundraising software stored therein. The fundraising software including a school identifier 321 to identify a specific designator for each participant primary and secondary school 411, a school designator provider 323 to provide the specific designator for at least one of the participant schools 411 to the consumer 711, a vendor informer 325 to inform the consumers 711 of which vendors within a community are participant vendors 611, and a vendor tracker 327 to track the sales incentives provided and transactions reported by each participant vendor 611 so that each participant school 411 and contributor 711 has information on the total money raised for each participant school 411 from each participant vendor 611.

Embodiments of the present invention also include another method for charitable contributions. The method including, but not limited to, enrolling a plurality of primary and secondary schools 411 and vendors 611 as participants in a charitable program. The method also including providing each of the participant plurality of primary and secondary schools 411 a designator to identify each particular primary and secondary school participating in the charitable program 111. The method further including attaching at least one designator to transactions by each of the plurality of participant vendors 611. The method including providing a sales incentive for each of the transactions having at least one designator attached thereto. The method further including reporting the sales incentives provided and transactions with at least one participant school 411 attached thereto reported by the vendor 611 to an administrative server 311.

Embodiments of the present invention also include a charitable contributions system. The system including, but not limited to, an administrator server 311 having a server computer 315 to access a server database 331 to store preselected charity information for each of a plurality of participant primary and secondary schools 411, and server memory 319 including fundraising software stored therein. The fundraising software including a school identifier 321 to identify a specific designator differentiating each participant primary and secondary school 411 from a plurality of participant primary and secondary schools 411, a school designator provider 323 to provide the specific designator for at least one of the participant schools 411 to the consumer 711, a vendor informer 325 to inform the consumers 711 of which vendors within a community are participant vendors 611, and a vendor tracker 327 to track sales incentives provided and transactions reported by each participant vendor 611 so that each participant school 411 and consumer 711 has information on the total money raised for each participant school 411 from each participant vendor 611. The system also including a plurality of vendor computers 615 in communication with the administrator server 311 through the communication network 211. Each of the vendor computers 615 having access to a vendor database 631 to store preselected transactional information, and having vendor memory 619 including vendor software stored therein. The vendor software including a participant tagger 623 to tag and associate at least one school designator selected by a consumer 711 with a sales transaction between the consumer 711 and a participant vendor 611, a donation recorder 625 to determine and record a monetary value to distribute to the selected participant school 411 represented by the school designator, a donation disburser 627 to disburse a disbursement of money associated by the school designator over the communication network 211, and a vendor reporter 629 to report sales incentives and disbursements of money associated by the school designator over the communication network 211.

Embodiments of the present invention also include a program product stored in a computer memory medium, as will be readily understood by those skilled in the art, to collect charitable contributions. The program product including, but not limited to, a school identifier 321 to identify a specific designator differentiating each participant primary and secondary school 411 from a plurality of participant primary and secondary schools 411. The program product also including a school designator provider 323 to provide the specific designator for at least one of the participant schools 411 when a contributor 711 identifies the at least one of the participant schools 411. The program product also including a vendor informer 325 to inform the contributor 711 of participant vendors 611, so that the possible contributor 711 has information on which vendors within a community are a participant vendor 611 providing sales incentives benefiting the participant schools 411. The program product further comprising a vendor tracker 327 to track sales incentives provided and transactions reported by each participant vendor 611 so that each participant school 411 and contributor 711 has information on the total money raised for each participant school 411 from each participant vendor 611.

A further aspect of a program product of the of an embodiment of the present invention is that the school designator provider 323 may further include a state provider 953 that provides a plurality of states for a contributor 711 to select as part of identifying the at least one of the participant schools 411 in order to narrow the number of possible participant schools 411 to the at least one participant school 411 the contributor 711 desires. The school designator provider 323 may also include a city provider 956 that provides a list of cities for the contributor 711 to select from that is responsive to a selection of a state from the state provider 953 as part of identifying the at least one of the participant schools 411. The school designator provider 323 may also include a school district provider 960 that provides a list of school districts for the contributor 711 to select from that is responsive to the selection of the state from the state provider 953 and a city from the city provider 956 as part of identifying the at least one of the participant schools 411. The school designator provider 323 may also include a school provider 961 that provides a list of schools for the contributor 711 to select from that is responsive to the selection of the state from the state provider 953, the selection of the city from the city provider 956, and a selection of a school district from the school district provider 960 as part of identifying the at least one of the participant schools 411. The school designator provider 323 may further include a school designator retriever 963 that retrieves and provides to the contributor 711 the at least one of the participant schools 411 selected by the contributor 711 responsive to the selection of the state from the state provider 953, the selection of the city from the city provider 956, the selection of the school district from the school district provider 960, and a selection of the school from the school provider 961 so that the contributor 711 has the specific designator for the at least one of the participant schools 411.

The present invention also includes software or program product for charitable contributions. The software including, but not limited to, a school identifier 321 to identify a specific designator differentiating each participant primary and secondary school 411 from a plurality of participant primary and secondary schools 411. The software also including a school designator provider 323 to provide the specific designator for at least one of the participant schools 411 when a contributor 711 identifies the at least one of the participant schools 411. The software also including a vendor informer 325 to inform the contributor 711 of participant vendors 611, so that the possible contributor 711 has information on which vendors within a community are a participant vendor 611 providing sales incentives benefiting the participant schools 411. The software further comprising a vendor tracker 327 to track sales incentives provided and transactions reported by each participant vendor 611 so that each participant school 411 and contributor 711 has information on the total money raised for each participant school 411 from each participant vendor 611.

The present invention also includes a computer program product embodied in a computer-readable medium, as will be readily understood by those skilled in the art, to collect charitable contributions. The computer program product including, but not limited to, a school identifier 321 to identify a specific designator differentiating each participant primary and secondary school 411 from a plurality of participant primary and secondary schools 411. The computer program product also including a school designator provider 323 to provide the specific designator for at least one of the participant schools 411 when a contributor 711 identifies the at least one of the participant schools 411. The computer program product also including a vendor informer 325 to inform the contributor 711 of participant vendors 611, so that the possible contributor 711 has information on which vendors within a community are a participant vendor 611 providing sales incentives benefiting the participant schools 411. The computer program product further comprising a vendor tracker 327 to track sales incentives provided and transactions reported by each participant vendor 611 so that each participant school 411 and contributor 711 has information on the total money raised for each participant school 411 from each participant vendor 611.

Yet other embodiments of the present invention also include a computer readable medium that is readable by a computer, the computer readable medium comprising a set of instructions that, when executed by the computer, cause the computer to perform the following operations to collect charitable contributions. The operations include, but not limited to, enrolling a plurality of primary and secondary schools 411 and vendors 611 as participants in a charitable program. The operations also include providing each of the participant plurality of primary and secondary schools 411 a designator to identify each particular primary and secondary school participating in the charitable program 111. The operations further include tracking sales transactions of each of the plurality of participant vendors 611 and having at least one designator attached to the transactions. The operations include providing a sales incentive for each of the transactions having at least one designator attached thereto. The operations further include reporting the sales incentives provided and transactions with at least one participant school 411 attached thereto reported by the vendor 611 to an administrative server 311.

Embodiments of the present invention still also include a computer memory element containing stored in signal bearing media a database 331. The database 331 containing data in computer-readable format. The data including, but limited to, a state, a city, and a school district 333 for each of the participant primary and secondary schools 411. The data including the promotional sales incentives 335 offered by each of the participant vendors 611. The data further including a tally of donations 339 made to each participant school 411 sorted by school designator and sorted by the promotional sales incentives.

Although embodiments of the present invention have been described in the context of a fully functional method, system, and program product of the present invention and/or aspects thereof re capable of being distributed in the form of computer readable medium, media, or means of instructions in a variety of forms for execution on one or more processors such as used in association with various types of computers, including, but not limited to, laptops, personal digital assistants, server computers, administration computers, and various other hardware, software, and/or firmware as understood by those skilled in the art. Also, these embodiments of the present invention can also apply regardless of the particular type of signal bearing media or means used to actually carry out the processing, distributing, or dosing as described herein. Examples of computer readable media or means include: nonvolatile, hard-coded type media such as read only memories (RAMs), erasable, electronically programmable read only memories (EEPROMs), including nonvolatile types, recordable and writable media such as CDs, DVDs, floppy disks, hard drives, and transmission type media such as digital and analog communication links.

Those skilled in the art will recognize that many changes and modifications may be made to the system and method of practicing the fundraising system 111 without departing the scope and spirit of the invention. For example, as understood by those skilled in the art, the administrator server 311 can provide coupons redeemable from each of the participant vendors 611 directly on the web site of the administrator server 311 rather than routing the participant supporter 711 to the individual vendor 611. Further, the participant supporter 711, after receiving a designator from the administrator server 311 and school designator provider 323, can visit an actual location or store of the vendor 611 and communicate the designator in person rather than using the communication network 211.

In the drawings and specification, there have been disclosed embodiments of the invention and, although specific terms are employed, they are used in a generic and descriptive sense only and not for the purpose of limitation, the scope of the invention being set forth in the following claims. The invention has been described in considerable detail with specific reference to these illustrated embodiments. It will be apparent, however, that various modifications and changes can be made within the spirit and scope of the invention as described in the foregoing specification.

1. A method for charitable contributions, the method comprising:
providing a plurality of participant primary and secondary schools engaged for participation in a charitable program for benefit of each of the plurality of participant schools and students of each of the participant schools, each of the participant schools having a school designator to differentiate the participant school from the remainder of the plurality of participant primary or secondary schools;
providing a plurality of participant vendors engaged for participation in the charitable program, each of the plurality of participant vendors having a vendor computer in communication with a communication network, the vendor computer having access to a vendor database to store information regarding promotional sales incentives offered by the participant vendor, usage of the promotional sales incentives, consumer accounts having school designators associated therewith, and redemption of the promotional sales incentives, and having vendor memory including vendor software stored therein, the vendor software including an account generator to create a customer account associated with each applying consumer, a participant tagger to tag and associate at least one school designator selected by the consumer with the customer account for each sales transaction between the consumer and the participant vendor, a donation recorder to determine and record a monetary value to distribute to the selected participant school represented by the school designator, a donation disburser to disburse a disbursement of money associated by the school designator over the communication network, and a vendor reporter to report sales incentives and disbursements of money associated by the school designator over the communication network;
providing a clearing bank in communication with the communication network, the clearing bank having a clearing bank computer having access to a clearing bank database to store information regarding deposits, withdrawals, and interest earned over time for each bank account created for each participant school, and having clearing bank memory including clearing bank software stored therein, the clearing bank software including an account creator to create a bank account for each participant school having a school designator, a donation sorter to identify a monetary value associated with each participant school in disbursements from each participant vendor, and a donation distributor to deposit said monetary value in the bank account created for each participant school by the account creator; and
providing an administrator server in communication with communication network, the administrator server having a server computer to access a server database to store information retrievable through the server via the communication network, the information including a state, a city, and school district for each of the participant primary and secondary schools, the information including the promotional sales incentives offered by each of the participant vendors, the information including a tally of donations made to each participant school sorted by school designator and sorted by the promotional sales incentives, and having server memory including fundraising software stored therein, the fundraising software including a school identifier to identify a specific designator for each participant primary and secondary school, a school designator provider to provide the specific designator for at least one of the participant schools to the consumer, a vendor informer to inform the consumers of which vendors within a community are participant vendors, and a vendor tracker to track the sales incentives provided and transactions reported by each participant vendor so that each participant school and consumer has information on the total money raised for each participant school from each participant vendor.

2. A method for charitable contributions according to claim 1, wherein the school identifier further comprises a school numberer that assigns a specific number to each participant primary and secondary school so that the specific designator is a specific number.

3. A method for charitable contributions according to claim 2, wherein the promotional sales incentives further comprise the participant vendor donating a portion of each transaction by the customer account having the school designator associated therewith.

4. A method for charitable contributions according to claim 2, wherein the promotional sales incentives further comprise the participant vendor donating a predetermined monetary amount for each transaction by the customer account having the school designator associated therewith.

5. A method for charitable contributions according to claim 2, wherein the promotional sales incentives further comprise the participant vendor reducing the amount of each transaction by the customer account having the school designator associated therewith by a predetermined amount, and wherein the vendor tracker reports the total money reduced for a total of each of the transactions by customer accounts having the school designator associated therewith.

6. A method for charitable contributions, the method comprising:
enrolling a plurality of schools and vendors as participants in a charitable program;
providing each of the participant plurality of schools a designator to identify each particular school participating in the charitable program;
attaching at least one designator to transactions by each of the plurality of participant vendors;
providing a sales incentive for each of the transactions having at least one designator attached thereto; and
reporting the sales incentives provided and transactions with at least one participant school attached thereto reported by the vendor to an administrative server.

7. A method for charitable contributions according to claim 6, the method further comprising tracking the sales incentives provided and transactions reported by each participant vendor by the administrative server so that each participant school has information on the total money raised for each participant school from each participant vendor.

8. A method for charitable contributions according to claim 6, the method further comprising conveying money from each of the participant vendors to a plurality of bank accounts for each of the participant primary and secondary schools based upon the transactions with at least one participant school attached thereto.

9. A method for charitable contributions according to claim 6, the method further comprising informing a plurality of possible consumers by one of the plurality of participant primary and secondary schools of the school designator for that participant school so that the possible consumers can provide that school designator for attaching by each of the participant vendors.

10. A method for charitable contributions according to claim 9, the method further comprising tracking the sales incentives provided and transactions reported by each participant vendor by the administrative server so that each participant school and each consumer has access to information on the total money raised for each participant school from each participant vendor.

11. A method for charitable contributions according to claim 6, wherein the providing a sales incentive step comprises donating a portion of each of the transactions having at least one designator attached thereto to each of the participant primary and secondary schools according to each of the school attached to each of the transaction.

12. A method for charitable contributions according to claim 6, wherein the providing a sales incentive step comprises donating a predetermined monetary amount per each of the transactions having at least one designator attached thereto to each of the participant primary and secondary schools according to each of the designators attached to each of the transaction.

13. A method for charitable contributions according to claim 6, wherein the providing a sales incentive step comprises reducing a transaction purchase price by a predetermined amount for each of the transactions having at least one designator attached thereto.

14. A charitable contributions system, the system comprising:
an administrator server having a server computer to access a server database to store preselected charity information for each of a plurality of participant primary and secondary schools, and having server memory including fundraising software stored therein, the fundraising software including a school identifier to identify a specific designator differentiating each participant primary and secondary school from a plurality of participant primary and secondary schools, a school designator provider to provide the specific designator for at least one of the participant schools to each of a plurality of consumers, a vendor informer to inform the consumers of which vendors within a community are members of a plurality participant vendors, and a vendor tracker to track sales incentives provided and transactions reported by each participant vendor so that each participant school and consumer has information on the total money raised for each participant school from each participant vendor; and
a plurality of vendor computers in communication with the administrator server, and having access to a vendor database to store preselected transactional information, and having vendor memory including vendor software stored therein, the vendor software including a participant tagger to tag and associate at least one school designator selected by each of the plurality of consumers with a sales transaction between each consumer and the participant vendor, a donation recorder to determine and record a monetary value to distribute to the selected participant school represented by the school designator, a donation disburser to disburse a disbursement of money associated by the school designator over the communication network, and a vendor reporter to report sales incentives and disbursements of money associated by the school designator over the communication network.

15. A charitable contributions system according to claim 14, wherein the each preselected transactional information of each of the plurality of participant vendors further comprises information regarding promotional sales incentives offered by each participant vendor, usage of the promotional sales incentives by sales transactions between the consumer and a participant vendor in which at least one school designator selected by the consumer is associated with the sales transaction.

16. A charitable contributions system according to claim 14, further comprising a clearing bank computer having access to a clearing bank database to store preselected banking information, and having clearing bank memory including clearing bank software stored therein, the clearing bank software including a donation sorter to sort a monetary value associated with each participant school in disbursements from each participant vendor, and a donation distributor to distribute deposits of said monetary value in a plurality of bank accounts responsive to the school designator for each participant school.

17. A program product stored on a tangible computer medium to collect charitable contributions, the program product comprising:
a school identifier to identify a specific designator differentiating each participant primary and secondary school from a plurality of participant primary and secondary schools;
a school designator provider to provide the specific designator for at least one of the participant schools when a contributor identifies the at least one of the participant schools;
a vendor informer to inform the contributor of participant vendors so that the possible contributor has information on which vendors within a community are a participant vendor providing sales incentives benefiting the participant schools; and
a vendor tracker to track sales incentives provided and transactions reported by each participant vendor so that each participant school and contributor has information on the total money raised for each participant school from each participant vendor.

18. A program product stored on a tangible computer medium to collect charitable contributions according to claim 17, wherein the school identifier further comprises a school numberer that assigns a specific number to each participant primary and secondary school so that the specific designator is a specific number.

19. A program product stored on a tangible computer medium to collect charitable contributions according to claim 17, wherein the sales incentives comprise the participant vendor donating a portion of each transaction by the customer account having the school designator associated therewith.

20. A program product stored on a tangible computer medium to collect charitable contributions according to claim 17, wherein the school designator provider further comprises:
a state provider that provides a plurality of states for a contributor to select as part of identifying the at least one of the participant schools in order to narrow the number of possible participant schools to the at least one participant school the contributor desires;
a city provider that provides a list of cities for the contributor to select from that is responsive to a selection of a state from the state provider as part of identifying the at least one of the participant schools;
a school district provider that provides a list of school districts for the contributor to select from that is responsive to the selection of the state from the state provider and a city from the city provider as part of identifying the at least one of the participant schools;
a school provider that provides a list of schools for the contributor to select from that is responsive to the selection of the state from the state provider, the selection of the city from the city provider, and a selection of a school district from the school district provider as part of identifying the at least one of the participant schools; and
a school designator retriever that retrieves and provides to the contributor the at least one of the participant schools selected by the contributor responsive to the selection of the state from the state provider, the selection of the city from the city provider, the selection of the school district from the school district provider, and a selection of the school from the school provider so that the contributor has the specific designator for the at least one of the participant schools.
